(19) United States
(12) Patent Application Publication
(10) Pub. No.: US 2024/0377576 A1
(43) Pub. Date: Nov. 14, 2024

(54) PLASTIC OPTICAL FIBER AND METHOD FOR PRODUCING THE SAME

(71) Applicant: NITTO DENKO CORPORATION, Osaka (JP)

(72) Inventors: Hiroshi OHMURA, Osaka (JP); Takashi SHIMIZU, Osaka (JP)

(73) Assignee: NITTO DENKO CORPORATION, Osaka (JP)

(21) Appl. No.: 18/553,102

(22) PCT Filed: Mar. 16, 2022
(86) PCT No.: PCT/JP2022/012085

§ 371 Date: Sep. 28, 2023

(30) Foreign Application Priority Data
Mar. 31, 2021 (JP) 2021-062065

(51) Int. Cl. G02B 6/02; B29D 11/00; G02B 6/028

(52) U.S. Cl. CPC G02B 6/02033; B29D 11/00682; G02B 6/028; B29K 2995/0031

(57) ABSTRACT

A plastic optical fiber suitable for reducing interfacial delamination between a clad and a coating layer. The plastic optical fiber includes: a core; a clad disposed on an outer circumference of the core and including a fluorine-containing resin; and a coating layer disposed on an outer circumference of the clad, the coating layer consisting of a material. The material has an elongation, as measured by a given test, of 0.05% or less.

### TECHNICAL FIELD

The present invention relates to a plastic optical fiber and a method for producing the plastic optical fiber.

### BACKGROUND ART

Plastic optical fibers include a core, which is a light transmitting portion, located in a central portion and a clad coating an outer circumference of the core. The core is made of a resin material having a high refractive index. The clad is made of a resin material having a lower refractive index than that of the resin material of the core so that light will stay within the core. Fluorine-containing resins are used as the resin materials of the core and the clad to reduce a transmission loss of the plastic optical fiber (e.g., Patent Literature 1).

Plastic optical fibers further include, for example, a coating layer disposed on an outer circumference of the clad. The coating layer can improve the mechanical strength of the plastic optical fiber.

### CITATION LIST

### Patent Literature

### Patent Literature 1: JP 2001-302935 A

### SUMMARY OF INVENTION

### Technical Problem

Studies by the present inventors have revealed that interfacial delamination tends to occur between a clad and a coating layer in the case where the clad includes a fluorine-containing resin. Occurrence of such interfacial delamination results in microbending in which the central axis of a core slightly bends. Microbending of a plastic optical fiber can increase a transmission loss thereof.

Therefore, the present invention aims to provide a plastic optical fiber suitable for reducing interfacial delamination between a clad and a coating layer.

### Solution to Problem

Studies by the present inventors have revealed that coating layers tend to absorb moisture in air and thereby slightly swell. The present inventors have found out that swelling of coating layers is a factor behind interfacial delamination between clads and coating layers, and have completed the present invention.

The present invention provides a plastic optical fiber including:
a core;
a clad disposed on an outer circumference of the core and including a fluorine-containing resin; and
a coating layer disposed on an outer circumference of the clad, the coating layer consisting of a material, wherein
the material has an elongation, as measured by the following test, of 0.05% or less,
the test includes: placing a strip-shaped specimen made of the material in a measurement atmosphere at 20° C. and 5% RH; humidifying the measurement atmosphere from 5% RH to 30% RH; and measuring the elongation of the specimen on the basis of a longitudinal length L0 of the specimen in a dry state and a longitudinal length L1 of the specimen after the humidification.

The present invention also provides a method for producing a plastic optical fiber,

the method including:
coating a layered body including a core and a clad with a material having an elongation, as measured by the following test, of 0.05% or less to produce a linear body including the core, the clad, and a coating layer disposed on an outer circumference of the clad, the clad being disposed on an outer circumference of the core and including a fluorine-containing resin; and
stretching the linear body, wherein
the test includes: placing a strip-shaped specimen made of the material in a measurement atmosphere at 20° C. and 5% RH; humidifying the measurement atmosphere from 5% RH to 30% RH; and measuring the elongation of the specimen on the basis of a longitudinal length L0 of the specimen in a dry state and a longitudinal length L1 of the specimen after the humidification.

### Advantageous Effects of Invention

The present invention can provide a plastic optical fiber suitable for reducing

interfacial delamination between a clad and a coating layer.

### BRIEF DESCRIPTION OF DRAWINGS

FIG. 1 is a schematic diagram showing an example of a cross-sectional structure of a plastic optical fiber of the present invention.

FIG. 2 is a schematic cross-sectional view showing an example of a production apparatus that can be used in production of plastic optical fibers.

FIG. 3 is a schematic diagram showing another example of the cross-sectional structure of the plastic optical fiber of the present invention.

### DESCRIPTION OF EMBODIMENTS

Embodiments of the present invention will be described hereinafter. The following description is not intended to limit the present invention to particular embodiments.

### Embodiment 1

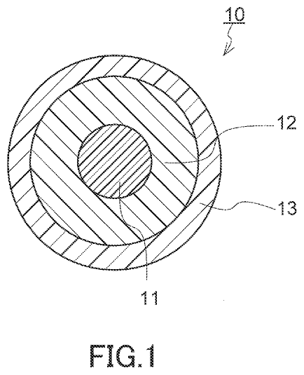

As shown in FIG. 1, a plastic optical fiber (hereinafter referred to as “POF”) 10 of the present embodiment includes a core 11, a clad 12, and a coating layer 13. The clad 12 is disposed on an outer circumference of the core 11 to coat the core 11. The clad 12 includes a fluorine-containing resin. The coating layer 13 is disposed on an outer circumference of the clad 12 to coat the clad 12. In a cross-section of the POF 10, the core 11, the clad 12, and the coating layer 13 are disposed, for example, concentrically. The clad 12 is in contact with, for example, each of the core 11 and the coating layer 13. The POF 10 is, for example, a graded-index (GI) POF.

In the POF 10 of the present embodiment, a material M of which the coating layer 13 consists has an elongation R of 0.05% or less. The elongation R can be measured using a commercially-available thermomechanical analyzer (TMA) by the following method. First, a strip-shaped specimen made of the material M is prepared. Dimensions of the specimen are, for example, 20 mm in length, 4 mm in width, and 4 mm in thickness. The specimen can be produced, for example, by cutting an unstretched sheet made of the material M. Next, this specimen is placed in a measurement atmosphere at 20° C. and 5% RH to dry the specimen. The specimen is preferably left for 5 hours or longer in the above atmosphere. A heating treatment may be performed beforehand to dry the specimen. Subsequently, the specimen in a dry state is measured for a longitudinal length L0. Herein, the term “dry state” refers to a state where the longitudinal length L0 of the specimen does not vary substantially in an atmosphere at 20° C. and 5% RH, i.e., a state where a rate at which the length L0 varies is substantially 0%/min in an atmosphere at 20° C. and 5% RH.

Next, the measurement atmosphere is humidified from 5% RH to 30% RH over 7 minutes. The specimen is left for 300 more minutes in the measurement atmosphere at 30% RH. A longitudinal length L1 of the specimen after the humidification is measured. The elongation R can be calculated by the following equation (1) on the basis of the lengths L0 and L1.

$$Elongation R ( \% ) = 1 \; 00 \times ( L 1 - L 0 ) / L 0 \qquad ( I )$$

The smaller the elongation R is, the more likely interfacial delamination between the clad 12 and the coating layer 13 is to be reduced. The elongation R is preferably 0.04% or less, more preferably 0.03% or less, even more preferably 0.02% or less, particularly preferably 0.018% or less, and may be 0.01% or less, or may be 0%.

### Core

The core 11 is a portion configured to transmit light. The core 11 has a higher refractive index than that of the clad 12. Because of this configuration, light incident on the core 11 is trapped inside the core 11 by the clad 12 and propagates in the POF 10.

The core 11 includes, for example, a highly transparent resin having a high transparency. Examples of the material of the core 11 include fluorine-containing resins, acrylic resins such as methyl methacrylate, styrene resins, and carbonate resins. The core 11 preferably includes a fluorine-containing resin because, in that case, a low transmission loss can be achieved in a wide wavelength region.

The fluorine-containing resin includes, for example, a fluorine-containing polymer (polymer (P)). It is preferred that the polymer (P) be substantially free of a hydrogen atom from the viewpoint of reducing light absorption attributable to stretching energy of a C—H bond. It is particularly preferred that every hydrogen atom bonded to a carbon atom be substituted by a fluorine atom. Herein, saying that the polymer (P) is substantially free of a hydrogen atom means that the hydrogen atom content in the polymer (P) is 1 mol % or less.

The polymer (P) preferably has a fluorine-containing aliphatic ring structure. The fluorine-containing aliphatic ring structure may be included in a main chain of the polymer (P), or may be included in a side chain of the polymer (P). The polymer (P) has, for example, a structural unit (A) represented by the following formula (1).

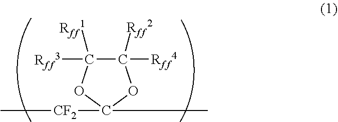

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

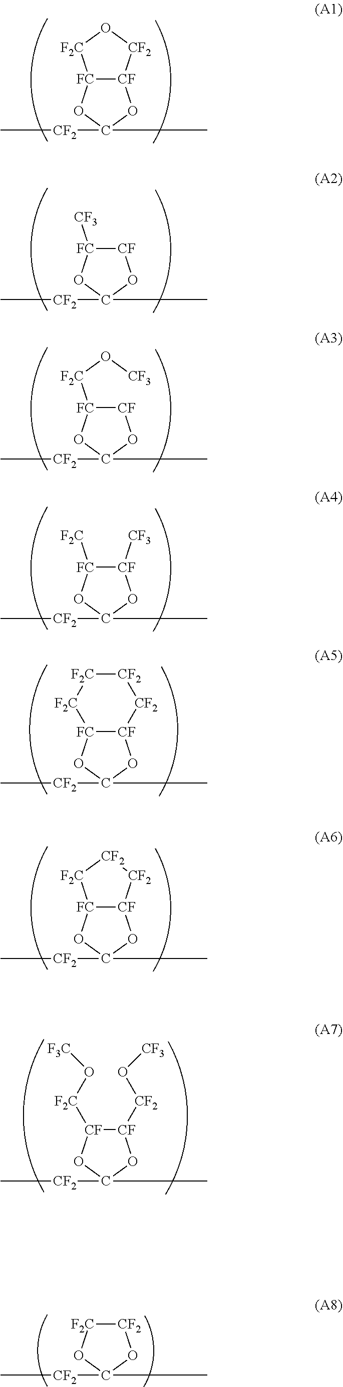

Among the structural units represented by the above formulae (A1) to (A8), the structural unit (A) is preferably the structural unit (A2), i.e., a structural unit represented by the following formula (2).

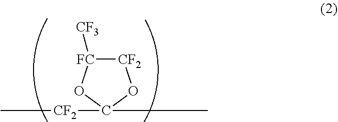

The polymer (P) may include one or more structural units (A). In the polymer (P), the amount of the structural unit (A) is preferably 20 mol % or more and more preferably 40 mol % or more of a total amount of all structural units. When including 20 mol % or more of the structural unit (A), the polymer (P) tends to have much higher thermal resistance. When including 40 mol % or more of the structural unit (A), the polymer (P) tends to have much higher transparency and much higher mechanical strength in addition to high thermal resistance. In the polymer (P), the amount of the structural unit (A) is preferably 95 mol % or less and more preferably 70 mol % or less of the total amount of all structural units.

The structural unit (A) is derived from, for example, a compound represented by the following formula (3). In the formula (3), R_{ff}¹ to R_{ff}⁴ are as described in the formula (1). It should be noted that the compound represented by the formula (3) can be obtained, for example, by an already-known manufacturing method such as a manufacturing method disclosed in JP 2007-504125 A.

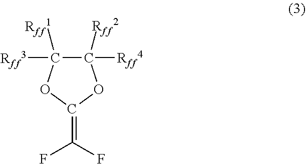

Specific examples of the compound represented by the above formula (3) include compounds represented by the following formulae (M1) to (M8).

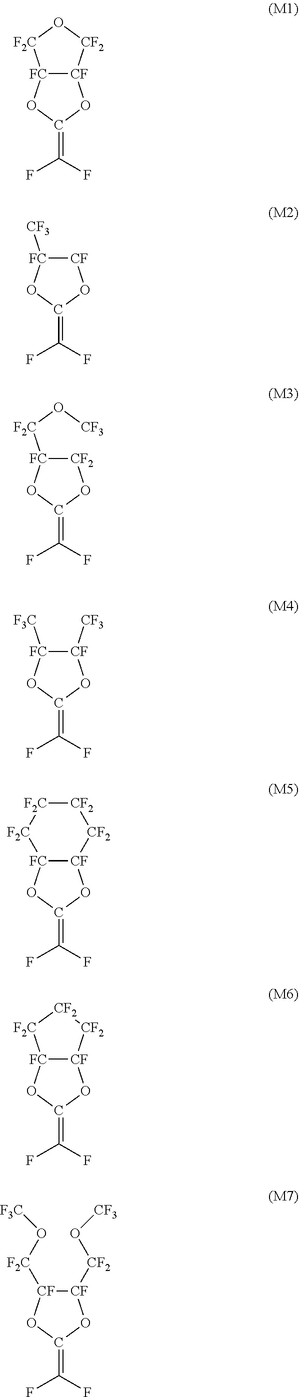

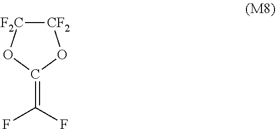 [SMILES: FC(F)=C1OC(F)(F)C(F)(F)O1]

The polymer (P) may further include an additional structural unit other than the structural unit (A). Examples of the additional structural unit include the following structural units (B) to (D).

The structural unit (B) is represented by the following formula (4).

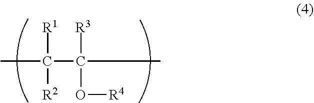

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (B). In the polymer (P), the amount of the structural unit (B) is preferably 5 to 10 mol % of the total amount of all structural units. The amount of the structural unit (B) may be 9 mol % or less or 8 mol % or less.

The structural unit (B) is derived from, for example, a compound represented by the following formula (5). In the formula (5), R¹ to R⁴ are as described for the formula (4). The compound represented by the formula (5) is a fluorine-containing vinyl ether such as perfluorovinyl ether.

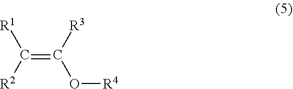

The structural unit (C) is represented by the following formula (6).

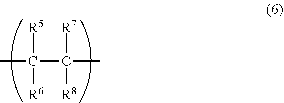

In the formula (6), R⁵ to R⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (C). In the polymer (P), the amount of the structural unit (C) is preferably 5 to 10 mol % of the total amount of all structural units. The amount of the structural unit (C) may be 9 mol % or less or 8 mol % or less.

The structural unit (C) is derived from, for example, a compound represented by the following formula (7). In the formula (7), R⁵ to R⁸ are as described for the formula (6). The compound represented by the formula (7) is a fluorine-containing olefin such as tetrafluoroethylene or chlorotrifluoroethylene.

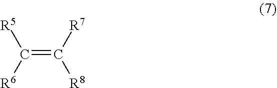

The structural unit (D) is represented by the following formula (8).

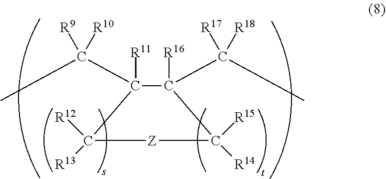

In the formula (8), Z represents an oxygen atom, a single bond, or—OC(R¹⁹R²⁰) O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R¹⁹R²⁰) O—, s+t may be 0).

The structural unit (D) is preferably represented by the following formula (9). The structural unit represented by the following formula (9) is a structural unit represented by the above formula (8), where Z is an oxygen atom, s is 0, and t is 2.

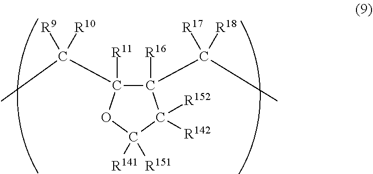

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The polymer (P) may include one or more structural units (D). In the polymer (P), the amount of the structural unit (D) is preferably 30 to 67 mol % of the total amount of all structural units. The amount of the structural unit (D) is, for example, 35 mol % or more, and may be 60 mol % or less or 55 mol % or less.

The structural unit (D) is, for example, derived from a compound represented by the following formula (10). In the formula (10), Z, R⁹ to R¹⁸, s, and t are as described for the formula (8). The compound represented by the formula (10) is a cyclopolymerizable fluorine-containing compound having two or more polymerizable double bonds.

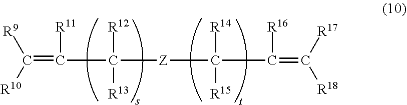

The structural unit (D) is preferably derived from a compound represented by the following formula (11). In the formula (11), R¹⁴¹, R¹⁴², R¹⁵¹, and R¹⁵² are as described for the formula (9).

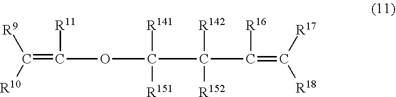

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═CFOCF₂CF(CF₃)CCl═CF₂
CF₂═CFOCF₂OCF═CF₂
CF₂═CFOCCl₂OCF═CF₂
CF₂═CClOCF₂OCC═CF₂

The polymer (P) may further include an additional structural unit other than the structural units (A) to (D). However, the polymer (P) is preferably substantially free of an additional structural unit other than the structural units (A) to (D). Saying that the polymer (P) is substantially free of an additional structural unit other than the structural units (A) to (D) means that the sum of the amounts of the structural units (A) to (D) is 95 mol % or more and preferably 98 mol % or more of the total amount of all structural units in the polymer (P).

The method for polymerizing the polymer (P) is not limited to a particular one, and a common polymerization method such as radical polymerization can be used. A polymerization initiator for the polymerization of the polymer (P) may be a fully-fluorinated compound.

A glass transition temperature (Tg) of the polymer (P) is, for example, but not particularly limited to, 100° C. to 140° C., and may be 105° C. or higher or 120° C. or higher. The term “Tg” herein refers to a midpoint glass transition temperature (T_{mg}) determined according to JIS K 7121:1987.

The core 11 may include the polymer (P) as a main component. The core 11, for example, consists essentially of the polymer (P). The core 11 may further include an additive such as a refractive index modifier.

In the case where the POF 10 of the present embodiment is, for example, a GI POF, the core 11 has a refractive-index distribution in which the refractive index varies in a diameter direction. Such a refractive-index distribution can be formed, for example, by adding a refractive index modifier to the fluorine-containing resin and diffusing the refractive index modifier in the fluorine-containing resin (for example, by thermal diffusion).

The refractive index of the core 11 is not limited to a particular value as long as the refractive index of the core 11 is higher than the refractive index of the clad 12. To achieve the POF 10 having a high numerical aperture, it is preferred that a difference between the refractive index of the core 11 and the refractive index of the clad 12 be large at a wavelength of light used. For example, the refractive index of the core 11 can be 1.340 or more or even 1.360 or more at a wavelength of light used (e.g., a wavelength of 850 nm). The upper limit of the refractive index of the core is, for example, but not particularly limited to, 1.4000 or less.

### Clad

As described above, the clad 12 includes a fluorine-containing resin. Any of the fluorine-containing resin described for the core 11 can be used as the fluorine-containing resin included in the clad 12. That is, the fluorine-containing resin included in the clad 12 may include the polymer (P) having the structural unit (A) represented by the above formula (1), particularly the structural unit represented by the above formula (2). The fluorine-containing resin included in the clad 12 may be the same as or different from the fluorine-containing resin included in the core 11.

The clad 12 may include the polymer (P) as its main component, and preferably consists essentially of the polymer (P). The clad 12 may further include an additive such as a refractive index modifier. The clad 12 may be free of an additive such as a refractive index modifier.

The refractive index of the clad 12 is not limited to a particular value as long as the refractive index of the clad 12 is determined on the basis of the refractive index of the core 11. The clad 12 may have a refractive index of, for example, 1.310 or less or even 1.300 or less at a wavelength of light used (e.g., a wavelength of 850 nm).

### Coating Layer

The material M of the coating layer 13 is not limited to a particular one as long as satisfying the above elongation R. The material M may include, for example, a resin material as its main component, and preferably consists essentially of a resin material. However, the fluorine-containing resin content in the material M is preferably low. In one example, the fluorine-containing resin content in the material M is, for example, 5 wt % or less, preferably 1 wt % or less. The material M is preferably substantially free of a fluorine-containing resin. In particular, the material M is preferably substantially free of fluorine. The material M may further include an additive other than the resin material.

The resin material included in the material M is preferably low in hygroscopicity. The hygroscopicity of the resin material tends to be affected by a heteroatom such as a nitrogen atom or an oxygen atom in the resin material.

The material M preferably includes, for example, at least one selected from the group consisting of a polycarbonate, a cycloolefin polymer, a cycloolefin copolymer, a polyester, a polyolefin, and a copolymer of two or more of monomers forming these polymers as the resin material, and particularly preferably includes a cycloolefin polymer or a cycloolefin copolymer as the resin material. The material M may include one of the above polymers or two or more of the above polymers as the resin material. That is, the material M may include a mixture of the above polymers.

The polycarbonate preferably includes a ring structure such as a benzene ring. The polycarbonate may be a modified polycarbonate which is a polycarbonate combined with a polyester. Specific examples of the polycarbonate include Xylex manufactured by SABIC Innovative Plastics and Panlite manufactured by TEIJIN LIMITED.

The cycloolefin polymer includes a structural unit derived from a cycloolefin. The number of blow carbons in the cycloolefin is, for example, but not particularly limited to, 5 to 10. Examples of the cycloolefin include norbornene.

The cycloolefin copolymer includes a structural unit derived from a cycloolefin and a structural unit derived from an olefin. Examples of the olefin include ethylene. Specific example of the cycloolefin copolymer include TOPAS (6013M, 6017S-04, 9506F, E-140, etc.) manufactured by TOPAS Advanced Polymers GmbH.

### POF Production Method

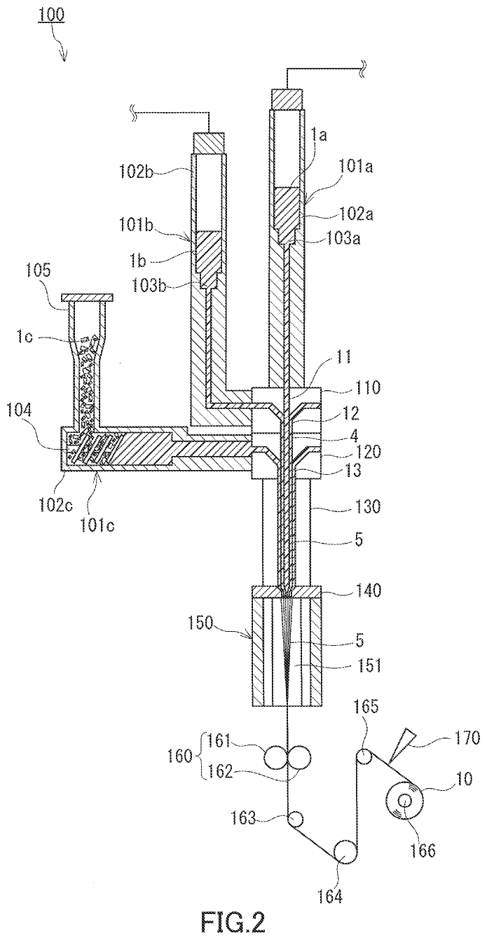

The POF 10 of the present embodiment can be produced, for example, by melt spinning. FIG. 2 is a schematic cross-sectional view showing an example of a production apparatus that can be used in production of the POF 10.

An apparatus 100 shown in FIG. 2 includes a first extrusion apparatus 101a for core formation, a second extrusion apparatus 101b for clad formation, and a third extrusion apparatus 101c for coating layer formation. The apparatus 100 further includes a first chamber 110 and a second chamber 120. The first chamber 110 and the second chamber 120 are vertically arranged in this order from top to bottom.

The first extrusion apparatus 101a includes a first holding portion 102a that holds a core material 1a and a first extrusion portion 103a that extrudes the core material 1a held in the first holding portion 102a from the first holding portion 102a. The first extrusion apparatus 101a may be further provided with a heating unit (not illustrated) such as a heater so that the core material 1a can be molten in the first holding portion 102a and that the molten core material 1a can be kept in a molten state until shaped. In this case, for example, the core material (preform) 1a in a rod shape is molten by being put in the first holding portion 102a through the upper opening portion of the first holding portion 102a and then being heated in the first holding portion 102a.

In the first extrusion apparatus 101a, the core material 1a is extruded from the first holding portion 102a through the first extrusion portion 103a, for example, by extrusion by gas to form the core 11. The core material 1a extruded through the first extrusion portion 103a to form the core 11 then moves vertically downward to be supplied to the first chamber 110 and the second chamber 120 in this order.

The second extrusion apparatus 101b includes a second holding portion 102b that holds a clad material 1b and a second extrusion portion 103b that extrudes the clad material 1b held in the second holding portion 102b from the second holding portion 102b. The second extrusion apparatus 101b extrudes the clad material 1b in a molten state to coat the outer circumference of the core 11 made of the core material 1a extruded from the first extrusion apparatus 101a. Specifically, the clad material 1b extruded from the second extrusion apparatus 101b is supplied to the first chamber 110. In the first chamber 110, the clad 12 coating the outer circumference of the core 11 can be formed by coating the core 11 made of the core material 1a with the clad material 1b. In this manner, a layered body 4 including the core 11 and the clad 12 coating the outer circumference of the core 11 is obtained. The layered body 4 moves from the first chamber 110 to the second chamber 120.

The third extrusion apparatus 101c includes, for example, a third holding portion 102c that holds a coating layer material 1c, a screw 104 disposed in the third holding portion 102c, and a hopper 105 connected to the third holding portion 102c. The coating layer material 1c corresponds to the material M whose elongation R, described above, is 0.05% or less. In the third extrusion apparatus 101c, for example, the coating layer material 1c in a pellet shape is supplied to the third holding portion 102c through the hopper 105. The coating layer material 1c supplied to the third holding portion 102c becomes soft and flowable, for example, by being kneaded by the screw 104 under heating. The softened coating layer material 1c is extruded from the third holding portion 102c by the screw 104.

The coating layer material 1c extruded from the third extrusion apparatus 101c is supplied to the second chamber 120. In the second chamber 120, the surface of the layered body 4 is coated with the coating layer material 1c. In this manner, a linear body 5 including the core 11, the clad 12, and the coating layer 13 disposed on the outer circumference of the clad 12 can be produced. That is, the production method of the present embodiment includes coating the layered body 4 with the material M whose elongation R, described above, is 0.05% or less to produce the linear body 5. The linear body 5 has the same structure as that of the POF 10, except that the outer diameters of the core 11, the clad 12, and the coating layer 13 are respectively different from those in the POF 10.

The linear body 5 moves from the second chamber 120 to a diffusion tube 130 disposed vertically under the second chamber 120. For example, a heater (not illustrated) for heating the linear body 5 may be disposed in the diffusion tube 130. In the diffusion tube 130, for example, the temperature and the viscosity of the linear body 5 passing inside are adjusted as appropriate. The diffusion tube 130 can diffuse a dopant such as a refractive index modifier in the linear body 5, the dopant being included in the linear body 5 passing through the diffusion tube 130.

The diffusion tube 130 communicates with an internal flow path of a nozzle 140. That is, a lower opening portion of the diffusion tube 130 communicates with an inlet of the nozzle 140, and the linear body 5 having passed through the diffusion tube 130 flows into the internal flow path through the inlet of the nozzle 140. The linear body 5 passes through the internal flow path to be reduced in diameter, and is then discharged into a fiber shape through an outlet of the nozzle 140.

The linear body 5 discharged into a fiber shape through the outlet of the nozzle 140 flows, for example, into an internal space 151 of a cooling pipe 150. The linear body 5 is cooled while passing through the internal space 151. The linear body 5 is then discharged to the outside of the cooling pipe 150 through an opening portion. The linear body 5 discharged from the cooling pipe 150, for example, passes between two rolls 161 and 162 of a nip roll 160 and then along guide rolls 163 to 165, and is wound as the POF 10 onto a winding roll 166. A displacement meter 170 for measuring the outer diameter of the POF 10 may be disposed near the winding roll 166, such as between the guide roll 165 and the winding roll 166.

In the present embodiment, the linear body 5 is stretched while moving to the winding roll 166. That is, the production method of the present embodiment includes stretching the linear body 5. Specifically, the linear body 5 softened is introduced into the nozzle 140, discharged from the nozzle 140, and wound onto the winding roll 166 to stretch the linear body 5. The POF 10 is obtained by stretching the linear body 5.

A stretch ratio at which the linear body 5 is stretched is not particularly limited, and is, for example, 800 or less, preferably 600 or less, more preferably 500 or less, even more preferably 400 or less, particularly preferably 200 or less, more particularly preferably 100 or less. The lower limit of the stretch ratio is, for example, but not particularly limited to, 10. The stretch ratio at which the linear body 5 is stretched tends to affect the condition of the interface between the clad 12 and the coating layer 13 of the POF 10. Specifically, the stretch ratio tends to affect the roughness (surface roughness) of a surface of the clad 12, the surface being the interface between the clad 12 and the coating layer 13. In the case where the stretch ratio is adjusted within the above range, particularly 500 or less, the surface roughness of the clad 12 tends to be appropriately adjusted and interfacial delamination between the clad 12 and the coating layer 13 tends to be reduced. It should be noted that the stretch ratio can be adjusted by adjustment of a diameter of the outlet of the nozzle 140, a rate of winding the linear body 5, etc.

In another aspect, the present invention provides a method for producing the plastic optical fiber 10 including:
the core 11;
the clad 12 disposed on the outer circumference of the core 11 and including the fluorine-containing resin; and
the coating layer 13 disposed on the outer circumference of the clad 12,
the method including
stretching the linear body 5 including the clad 11, the clad 12, and the coating layer 13 at a stretch ratio of 500 or less to obtain the plastic optical fiber 10. cl Embodiment 2

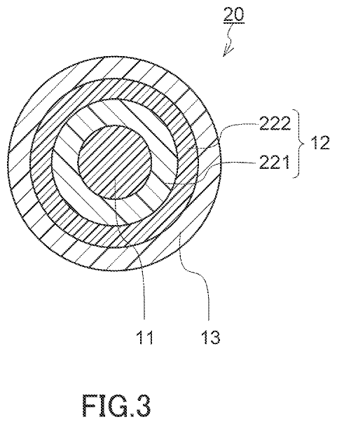

The clad 12 of the POF 10 of Embodiment 1 may have a plurality of layers. For example, as shown in FIG. 3, the clad 12 of a POF 20 of the present embodiment 2 has a two-layer structure composed of a first clad layer 221 disposed in contact with the core 11 and a second clad layer 222 disposed closer to the outer circumference of the clad 12 than the first clad layer 221 is. The second clad layer 222 is in contact with, for example, each of the first clad layer 221 and the coating layer 13. Except for the above, the structure of the POF 20 is the same as that of the POF 10 of Embodiment 1. Therefore, the elements common between the POF 10 of Embodiment 1 and the POF 20 of the present embodiment are denoted by the same reference characters, and the description of such elements may be omitted.

The materials of the first clad layer 221 and the second clad layer 222 are as described above for the clad 12. The material of the first clad layer 221 may be the same as or different from the material of the second clad layer 222.

The second clad layer 222 preferably has a lower refractive index than that of the first clad layer 221 because, in that case, it is ensured that light leaking from the core 11 into the first clad layer 221 is totally reflected by the second clad layer 222 and trapped in the clad 12. For example, the first clad layer 221 preferably has an refractive index in the range of 1.325 to 1.335. For example, the second clad layer 222 preferably has an refractive index lower than that of the first clad layer 221 and in the range of 1.290 to 1.325.

The clad 12 has a two-layer structure in the example shown in FIG. 3; however, the number of layers in the clad 12 is not limited to two, and the clad 12 may include three or more layers. In the case where the clad 12 is composed of a plurality of layers, for example, even when light incident on the core 11 fails to be totally reflected at the interface between the core 11 and the clad 12 and leaks to the clad 12 side, the leaked light can be totally reflected by a clad layer closer to the outer circumference of the clad 12 and thus an optical loss can be reduced. In the case where the clad 12 has three or more clad layers, it is preferred that, in the clad 12, a clad layer disposed closest to an inner circumference of the clad 12 have the highest refractive index and a clad layer disposed closer to the outer circumference of the clad 12 have a lower refractive index in order to ensure that light leaking into the clad 12 is trapped within the clad 12,.

### EXAMPLES

Hereinafter, the present invention will be described in more detail with reference to Examples and Comparative Example. The present invention is however not limited by these.

### Example 1

### [Fluorine-Containing Polymer]

First, 100 g of perfluoro-4-methyl-2-methylene-1,3-dioxolane (a compound, PFMMD, represented by the above formula (M2)) and 1 g of perfluorobenzoyl peroxide were put in a glass tube, which was then sealed. After oxygen in the system was removed by freeze-pump-thaw cycling, the glass tube was charged with argon and then heated at 50° C. for several hours. The contents thereby turned solids, which were further heated at 70° C. overnight to obtain 100 g of a transparent stick. The stick was dissolved in a hexafluorobenzene solution, to which chloroform was added for precipitation. The product was thereby purified. A fluorine-containing polymer was obtained in this manner.

### [Core Material]

The above fluorine-containing polymer and a refractive index modifier (a low polymer of chlorotrifluoroethylene) were molten and mixed to produce a core material. The refractive index modifier concentration in the core material was 10 wt %.

### [Clad Material]

The above fluorine-containing polymer was used as a clad material.

[Coating layer material]

Xylex (manufactured by SABIC Innovative Plastics) was used as a coating layer material.

### [POF]

Melt spinning was performed using the above core material, the above clad material, and the above coating layer material. The melt spinning was performed using the production apparatus 100 as shown in FIG. 2. In the melt spinning, the linear body 5 was stretched at a stretch ratio of 75 while moving to the winding roll 166. A POF of Example 1 was obtained in this manner.

### Comparative Example 1 and Examples 2 and 3

POFs of Comparative Example 1 and Examples 2 and 3 were obtained in the same manner as in Example 1, except that the type of the coating layer material and the stretch ratio for the linear body were changed as shown in Table 1. In Comparative Example 1, DURABIO T-7450 (manufactured by Mitsubishi Chemical Corporation) was used as the coating layer material. In Example 2, TOPAS (manufactured by TOPAS Advanced Polymers GmbH) was used as the coating layer material.

### [Elongation R of Coating Layer Material]

The coating layer materials were measured for their elongations R by the above-described method. Dimensions of strip-shaped specimens made of the coating layer materials were 20 mm in length, 4 mm in width, and 4 mm in thickness.

### [Interfacial Delamination]

Each POF was observed using an ultrasonic microscope to evaluate interfacial delamination between the clad and the coating layer according to the following criteria.
o: Interfacial delamination is observed.
x: Interfacial delamination is not observed.

TABLE 1

| | Coating layer material | | | |
|---|---|---|---|---|
| | | Elongation | Stretch | Interfacial |
| | Product code | R (%) | ratio | delamination |
| Example 1 | Xylex | 0.018 | 75 | ◯ |
| | (polycarbonate) | | | |
| Comparative | DURABIO | 0.063 | 75 | X |
| Example 1 | (polycarbonate) | | | |
| Example 2 | TOPAS | 0.000 | 75 | ◯ |
| | (cycloolefin | | | |
| | copolymer) | | | |
| Example 3 | Xylex | 0.018 | 470 | ◯ |
| | (polycarbonate) | | | |

As can be understood from Table 1, the POFs of Examples including the coating layers made of the materials having an elongation R of 0.05% or less reduce interfacial delamination, compared to the POF of Comparative Example. It is inferred that the POFs of Examples reduce an increase in transmission loss due to microbending.

### INDUSTRIAL APPLICABILITY

The POF of the present embodiment is suitable for use in high-speed communication.

1. A plastic optical fiber comprising:
a core;
a clad disposed on an outer circumference of the core and including a fluorine-containing resin; and
a coating layer disposed on an outer circumference of the clad, the coating layer consisting of a material, wherein
the material has an elongation, as measured by the following test, of 0.05% or less,
the test includes: placing a strip-shaped specimen made of the material in a measurement atmosphere at 20° C. and 5% RH; humidifying the measurement atmosphere from 5% RH to 30% RH; and measuring the elongation of the specimen on the basis of a longitudinal length L0 of the specimen in a dry state and a longitudinal length L1 of the specimen after the humidification.

2. The plastic optical fiber according to claim 1, wherein the elongation is 0.018% or less.

3. The plastic optical fiber according to claim 1, wherein the material is free of a fluorine-containing resin.

4. The plastic optical fiber according to claim 1, wherein the material includes at least one selected from the group consisting of a polycarbonate, a cycloolefin polymer, a cycloolefin copolymer, a polyester, a polyolefin, and a copolymer of two or more of monomers forming these polymers.

5. The plastic optical fiber according to claim 1, wherein the material includes a cycloolefin polymer or a cycloolefin copolymer.

6. The plastic optical fiber according claim 1, wherein the clad includes: a first clad layer disposed in contact with the core; and a second clad layer disposed closer to the outer circumference of the clad than the first clad layer is.

7. The plastic optical fiber according to claim 1, wherein the fluorine-containing resin included in the clad includes a polymer having a structural unit represented by the following formula (1): 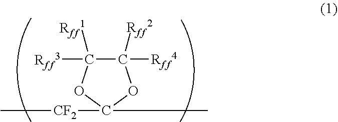
where R_{ff}¹ to R_{ff}⁴ each independently represent a fluorine atom, a perfluoroalkyl group having 1 to 7 carbon atoms, or a perfluoroalkyl ether group having 1 to 7 carbon atoms, and R_{ff}¹ and R_{ff}² are optionally linked to form a ring.

8. The plastic optical fiber according to claim 7, wherein the structural unit is represented by the following formula (2):

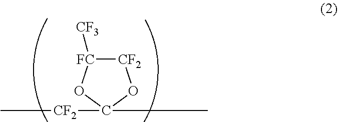

9. The plastic optical fiber according claim 1, wherein the core includes a fluorine-containing resin.

10. A method for producing a plastic optical fiber, the method comprising:
coating a layered body including a core and a clad with a material having an elongation, as measured by the following test, of 0.05% or less to produce a linear body including the core, the clad, and a coating layer disposed on an outer circumference of the clad, the clad being disposed on an outer circumference of the core and including a fluorine-containing resin; and
stretching the linear body, wherein
the test includes: placing a strip-shaped specimen made of the material in a measurement atmosphere at 20° C. and 5% RH; humidifying the measurement atmosphere from 5% RH to 30% RH; and measuring the elongation of the specimen on the basis of a longitudinal length L0 of the specimen in a dry state and a longitudinal length L1 of the specimen after the humidification.

11. The method according to claim 10, wherein a stretch ratio at which the linear body is stretched is 500 or less.

12. The method according to claim 10, wherein the linear body softened is introduced into a nozzle, discharged from the nozzle, and wound to stretch the linear body.
